(19) United States
(12) Patent Application Publication
(10) Pub. No.: US 2017/0303037 A1
(43) Pub. Date: Oct. 19, 2017

(54) ENHANCED AUDIO LANDSCAPE

(71) Applicant: Panasonic Automotive Systems Company of America, Division of Panasonic Corporation of North America, Peachtree City, GA (US)

(72) Inventors: SACHIKO KOBAYASHI, NOVI, MI (US); PATRICK HANSLITS, CLARKSTON, MI (US); JILLIAN HALL, FARMINGTON HILLS, MI (US); ILYA VEKSLER, WEST BLOOMFIELD, MI (US); MARTIN EZEQUIEL NESPOLO, GROSSE POINTE WOODS, MI (US)

(73) Assignee: Panasonic Automotive Systems Company of America, Division of Panasonic Corporation of North America

(21) Appl. No.: 15/487,921

(22) Filed: Apr. 14, 2017

Related U.S. Application Data
(60) Provisional application No. 62/324,562, filed on Apr. 19, 2016.

(51) Int. Cl. H04R 3/00; G10K 11/178; H04R 1/40

(52) U.S. Cl. CPC H04R 3/005; H04R 1/406; G10K 11/1786; G10K 2210/1282; H04R 2499/13

(57) ABSTRACT

The inventive EAL may generally enhance a driver's spatial awareness by providing the driver with intuitive/familiar audible warnings with directionality which can be enhanced with visual warnings as well as other technologies such as ANC and Zoned audio. Thus, the driver can understand the meaning of the warning and where it is coming from so he can react to it faster. In a specific embodiment, a motor vehicle includes a plurality of outside microphones mounted in association with an outer surface of the vehicle. A plurality of loudspeakers are disposed within the passenger compartment of the vehicle. A processing device identifies a sound of interest in microphone signals received from the outside microphones. It is determined from the microphone signals a direction in which the sound of interest is traveling. This may also be done with sensors, GPS, V2X, etc. In response to the identification of the sound of interest, playing at least one of the microphone signals on the loudspeakers is begun such that the sound of interest in the microphone signal and heard by the driver on the loudspeakers is perceived by a driver of the vehicle to be traveling in the determined direction.

### CROSS-REFERENCE TO RELATED APPLICATION

This application claims benefit of U.S. Provisional Application No. 62/324,562 filed on Apr. 19, 2016, which the disclosure of which is hereby incorporated by reference in its entirety for all purposes.

### FIELD OF THE INVENTION

The disclosure relates to the field of audio systems, and, more particularly, to audio systems in motor vehicles.

### BACKGROUND OF THE INVENTION

Currently known audible warnings provided in vehicles may be overwhelming to the driver because they present additional audible cues on top of all the other sounds that the driver hears. Thus, some of the audible warnings may be missed by the driver because of all the other extraneous noises surrounding the driver, or because the driver is cognitively overloaded.

Another problem is that currently known audible warnings provided in vehicles do not possess directional aspects or directional indicators. Most of the warning sounds make it seem that the sounds originate inside of the car. Many of today's audible warnings do not have directionality so drivers have to look around to find what it is warning about. Also, most of visual warnings are displayed inside of the vehicle thus pulling drivers attention inside of the vehicle while most of the time, what the vehicle is warning about is actually outside of the car. Thus, the driver's attention and eyes are pulled inside of the car instead of to the potential danger itself.

Most of the time, the meanings of the audible warnings (e.g., beeps and tones) and even the visual warnings have to be learned by the driver. Audible warnings are general and vary between vehicles, so they need to be learned. Thus, the warnings may be confusing or annoying and may not be as effective as expected if the driver does not know what the warning means.

### SUMMARY

The present invention may provide an enhanced audio landscape (EAL), which is a directional and enhanced audio coupled with active noise cancellation (ANC) to reduce unwanted noise (and thereby minimize distraction) and provide the driver with clear directional audio warnings (e.g., enhanced “sounds of interest”) to help clearly identify and locate the potential dangers by building a clear spatial map of the surroundings in the driver's mind. This may be especially helpful for drivers who are overwhelmed by information and stimuli in their environment. That is, the inventive EAL may help the overwhelmed, fatigued and/or distracted driver become aware of his surroundings without adding more distraction.

The inventive EAL may help the driver safely and clearly identify potential danger because “unwanted” sounds may be minimized and a “sound of interest” (e.g., the sound of the potential danger) may be enhanced. Thus, the driver is provided with a clear and focused audible warning of potential danger without having to hear other extraneous sounds. The active noise cancellation may be optional as long as the warning sounds are clear to the driver. Another optional technology may be Zoned Audio. It can be used to provide the right warning in the right way at the right time just to the driver while the passengers enjoy their own sounds (e.g., entertainment, etc.).

The “sound of interest” may be a sound directly from a potential danger which is intuitive or familiar warning sounds that are quickly recognized, such as a siren sound, a braking sound, and a sound of a vehicle that is in the driver's blind spot. In other cases, in which the danger cannot be associated with an intuitive warning sound (such as pedestrians, animals, or a warning for a school zone), such tones may be provided, but with directionality. So, in case the danger cannot be associated with intuitive or familiar warning sounds that are quickly recognized, verbal warnings (like “it's a school zone” using child's voice) or tones may be used, but with directionality. Thus, the audible warnings are intuitive and are universal across different countries for the most part. Universal warnings may be used when possible, but different sounds can be used if this technology is coupled with Driver Monitoring System and cloud connectivity which could identify the driver's preferred language.

The system also provides directionality of the potentially dangerous event because the “sound of interest” is presented from the direction of the actual event relative to the car. This directionality may pull the driver's attention and eyes in the direction of the potential danger, which is not inside of the vehicle, and helps the driver to better react to the potential danger faster. The inventive EAL may also be used to pull the driver's attention forward of the vehicle when the driver is looking away. For example, EAL may be combined with a driver monitoring system.

“Unwanted” sounds (e.g., distracting sounds) that can be muted or attenuated include, but are not limited to, any exterior noise, interior noise from a vehicle system (e.g., infotainment system), a telephone call, which may be enabled by connectivity on in-vehicle devices, etc. The unwanted sounds could also be sounds from a passenger's entertainment system such as from portable devices brought into the vehicle. For example, music, phone ringing sounds or beeps/tones, and other sounds that may be misleading to the driver may be muted for the driver.

In one embodiment, the invention comprises a motor vehicle including a plurality of outside microphones mounted near or on an outer surface of the vehicle. A plurality of loudspeakers are disposed within the passenger compartment of the vehicle. A processing device identifies a sound of interest in microphone signals received from the outside microphones. It is determined from the microphone signals a direction in which the sound of interest is traveling. In response to the identification of the sound of interest, at least one of the microphone signals is begun to be played on the loudspeakers such that the sound of interest in the microphone signal and heard by the driver on the loudspeakers is perceived by the driver to be traveling in the determined direction. The “sound” may be simulated or created so the driver does not get confused by hearing both sounds (“real” sound from exterior and interior “enhanced” sound).

In another embodiment, the invention comprises a method of producing sounds in a motor vehicle, including mounting a plurality of outside microphones in association with an outer surface of the vehicle. A plurality of loudspeakers are provided within a passenger compartment of the vehicle. A sound of interest is identified in outside microphone signals received from the outside microphones. A direction in which the sound of interest is approaching the vehicle is determined from the outside microphone signals. In response to the identifying of the sound of interest, at least one of the outside microphone signals is begun to be played on the loudspeakers such that the sound of interest in the outside microphone signal and heard by a driver of the vehicle on the loudspeakers is perceived by the driver to be coming from the determined direction.

In yet another embodiment, the invention comprises a motor vehicle including a plurality of outside microphones mounted in association with an outer surface of the vehicle. An inside microphone is disposed within a passenger compartment of the vehicle. A plurality of loudspeakers emit sounds into a passenger compartment of the vehicle. A processing device identifies a sound of interest in outside microphone signals received from the outside microphones. A direction in which the sound of interest is approaching the vehicle is determined from the outside microphone signals. The direction in which the sound of interest is approaching the vehicle could also be determined via vehicle-to-infrastructure (V2X), cloud information, etc. In response to the identification of the sound of interest, playing of at least one of the outside microphone signals on the loudspeakers is commenced such that the sound of interest in the outside microphone signal and heard by a driver of the vehicle on the loudspeakers is perceived by the driver to be coming from the determined direction. The processing device includes an active noise controller which receives a signal from the inside microphone, attenuates sounds other than the sound of interest in the outside microphone signal, and attenuates sounds originating in the vehicle.

An advantage of the present invention is that it may provide directionality indications relative to the potential danger. Thus, the inventive EAL may help a driver to keep his eyes on the road and focus on driving but still be aware of the surrounding potential danger, and keep his hands on the steering wheel while the warnings are being provided. EAL may work well when coupled with a visual warning, and preferably one that does not pull the driver's attention to the inside of the vehicle.

### BRIEF DESCRIPTION OF THE DRAWINGS

A better understanding of the present invention will be had upon reference to the following description in conjunction with the accompanying drawings.

FIG. 1 is a block diagram of one embodiment of a vehicle of the present invention including an enhanced audio landscape arrangement.

FIG. 2 is a schematic diagram of types of sounds that may be attenuated and blocked over time according to one embodiment of the invention.

FIG. 3 is a flow chart of one embodiment of a method of the invention for producing sounds in a motor vehicle.

### DETAILED DESCRIPTION OF THE PREFERRED EMBODIMENTS

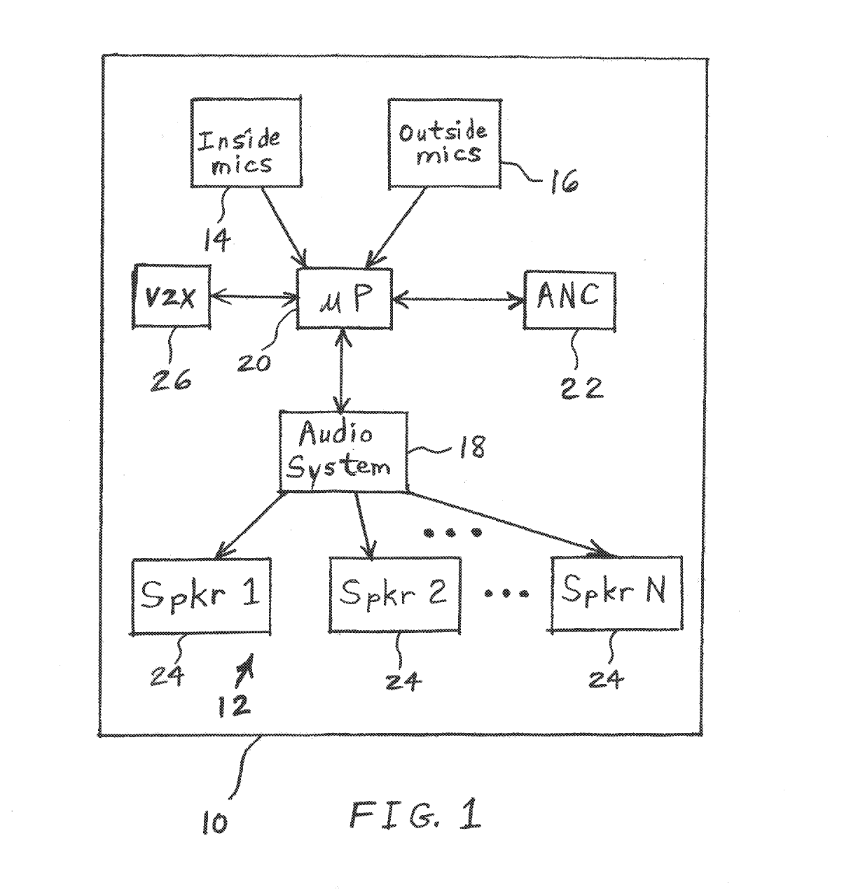

FIG. 1 illustrates one embodiment of a vehicle 10 of the present invention including an enhanced audio landscape arrangement 12. Arrangement 12 includes one or more inside microphones 14 disposed inside the passenger compartment, and one or more outside microphones 16 disposed at various locations along the outside surface of vehicle 10. For example, three outside microphones 16 may be spaced 120 degrees apart around the lateral periphery of vehicle 10; or four outside microphones 16 may be spaced 90 degrees apart around the lateral periphery of vehicle 10. Arrangement 12 also includes an audio system 18, which may include a radio, compact disc player, etc.; an electronic processor 20, an active noise controller 22, and a plurality of loudspeakers 24 disposed within the passenger compartment. A V2X module 26 or connectivity to the cloud can also be included to provide information about objects and activity around the car.

During use, inside microphones 14 may pick up sounds inside the passenger compartment, such as conversations (e.g., passenger phone calls), music (e.g., from audio system 18), engine noise, etc. Outside microphones 16 may pick up sounds outside the vehicle, which may include both noise (e.g., steady-state traffic noise, other steady-state noises, wind, conversations, etc.) and sounds of interest (e.g., screeching noises from hard braking, sirens, crashing sounds, etc.).

Active noise controller 22 may sense, via inside microphones 14, noise in the passenger compartment and cancel out or attenuate the noise by sending a canceling signal to speakers 24 via processor 20 and audio system 18. Thus, only the non-noise signal from audio system 18 is played on speakers 24.

Processor 20 may monitor the outputs of outside microphones 16 for sounds of interest. Each type of sound of interest may have its own frequency characteristic and/or time domain signature, which may be identified by processor 20 in the outputs of outside microphones 16. The sounds of interest may have been simulated or pre-recorded in a laboratory in order to determine what frequency characteristics and/or time domain signatures that processor 20 should look for in the outputs of outside microphones 16. After detecting the sound of interest, or in the process of detecting the sound of interest, processor 20 may determine the direction in which the sound of interest approaches vehicle 10. More particularly, processor 20 may determine the magnitude of the sound of interest at each of outside microphones 16 individually. By comparing these magnitudes at each outside microphone 16, processor 20 may calculate the direction in which the sound of interest is approaching vehicle 10. Outside microphones 16 may be unidirectional microphones all facing in an outward direction in order to better distinguish the traveling direction of the sound of interest.

Next, processor 20 may reproduce and possibly amplify the sound of interest within the passenger compartment via speakers 24. By playing the sound of interest at different volume levels on at least two of speakers 24, processor 20 may replicate within the passenger compartment the direction of the sound of interest outside vehicle 10. Thus, the sound of interest, as heard and perceived by the driver through speakers 24, may come from the same direction as the source of the sound of interest outside vehicle 10, and may move with the sound of interest (e.g., surround sound).

Accordingly, the driver may instinctively look in the perceived direction of the sound of interest, which may match the direction in which the driver may see the source of the sound of interest outside vehicle 10. Other sounds (e.g., music) or noises being played through speakers 24 may be attenuated while the sound of interest is being played through speakers 24 so that the sound of interest can be more easily heard by the driver and can more easily catch the attention of the driver.

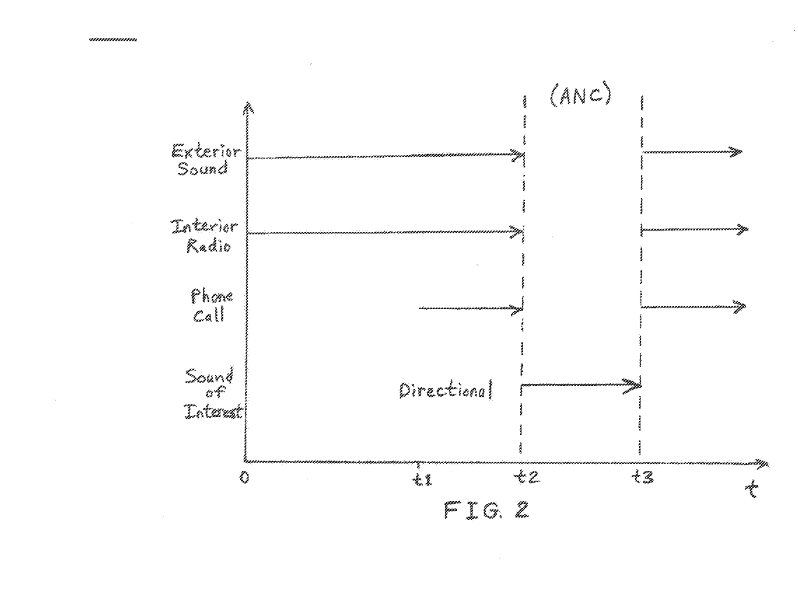

FIG. 2 illustrates different types of sounds that may be attenuated, blocked passed, or amplified versus time according to one embodiment of the invention. From time=0 to time=t1, exterior sounds and the interior radio may be played on speakers 24. Beginning at time=t1, a phone call by a passenger of the car may begin, and that phone call too may be played on speakers 24.

Beginning at time=t2, processor 20 may recognize a sound of interest picked up by outside microphones 16. The sound of interest may then be digitally isolated by processor 20 from the other exterior sounds, and processor 20 may begin playing and possibly amplifying the sound of interest on speakers 24. The digital isolation of the sound of interest may include using ANC 22 to produce canceling signals to cancel out the exterior sounds other than the sound of interest picked up by outside microphones 16. Other sounds, such as exterior sounds, the interior radio, and the ongoing telephone call, may be attenuated or blocked from being played on speakers 24.

Beginning at time=t3, processor 20 may recognize that the sound of interest has ceased and may stop isolating, playing and/or amplifying the sound of interest on speakers 24. Other sounds, such as exterior sounds, the interior radio, and the ongoing telephone call, may no longer be attenuated or blocked from being played on speakers 24.

The invention has been described herein as recognizing an external “sound of interest” from a potential danger, such as a siren sound, a braking sound, or a sound of a vehicle that is in the driver's blind spot, and then reproducing the sound within the vehicle. It is also possible within the scope of the invention to use other vehicle systems to identify a potential danger and, in response thereto, produce an audio signal to draw the driver's attention appropriately. In one embodiment, the vehicle may have a radar-based blind spot warning system that confirms or first discovers the presence of another vehicle in the driver's blind spot, and responds thereto by causing the sound of the other vehicle to be reproduced in the vehicle from the direction of the blind spot. Moreover, a driver monitoring system may detect the positions of the driver's head and eyes and trigger the blind spot warning system more quickly or with a lower detection threshold if the positions of the driver's head and eyes indicate that the driver is not paying full attention to the road.

In another embodiment, a vehicle attention management system may draw the driver's attention in a direction in front of the vehicle if there is sensed a distraction that might pull his attention from the road. Such a distraction may include an incoming telephone call. The driver's attention may be drawn in a direction in front of the vehicle by a tone or beep that sounds like it is coming from a direction forward of the vehicle.

In yet another embodiment, a forward-facing vehicle camera may determine when a traffic light turns green when the vehicle is stopped at a red light. A driver monitoring system may detect the positions of the driver's head and eyes and trigger an audio cue to remind the driver to accelerate if the positions of the driver's head and eyes indicates that the driver's eyes are not directed forward, or that the driver is not paying full attention to the traffic light and road.

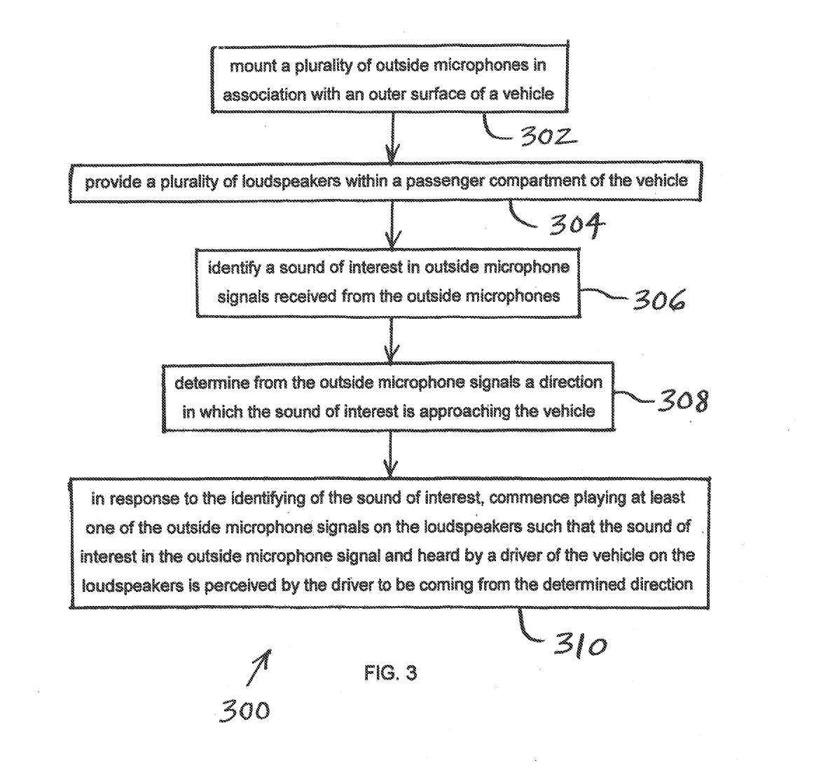

FIG. 3 illustrates one embodiment of a method 300 of the invention for producing sounds in a motor vehicle. In a first step 302, a plurality of outside microphones are mounted in association with an outer surface of the vehicle. For example, outside microphones 16 may be mounted such that they are evenly spaced apart along an outside surface of vehicle 10 and such that each of microphones 16 is approximately at a same vertical level.

In a next step 304, a plurality of loudspeakers are provided within a passenger compartment of the vehicle. For example, loudspeakers 24 may be spaced out around the interior of vehicle 10.

Next, in step 306, a sound of interest in outside microphone signals received from the outside microphones is identified. For example, processor 20 may recognize in signals from microphones 16 a frequency characteristic or time domain signature of a sound of interest, such as screeching noises from hard braking, sirens, crashing sounds, etc.

In step 308, a direction in which the sound of interest is approaching the vehicle is determined from the outside microphone signals. For example, processor 20 may determine from the different magnitudes of the outside microphone signals, and from the different locations of outside microphones 16, a direction in which the sound of interest is approaching vehicle 10.

In a final step 310, in response to the identifying of the sound of interest, at least one of the outside microphone signals is begun to be played on the loudspeakers such that the sound of interest in the outside microphone signals and heard by a driver of the vehicle on the loudspeakers is perceived by the driver to be coming from the determined direction. For example, in response to processor 20 recognizing the outside microphone signal as a sound of interest, processor 20 may transmit respective signals to speakers 24 such that the signals may have the same content, but different amplitudes so that speakers 24 may each play the signal with a different loudness. The amplitudes of the signals sent to speakers 24 may be set such that the driver hears speakers 24 and perceives the combined sound as coming from the same direction as the actual real-life sound outside of vehicle 10 comes from.

The invention has been described herein as including two methods of capturing the sound. One method includes using microphones on the exterior of the vehicle. The other method includes using V2X or Cloud services. In another method, a vehicle equipped sensor is used such as a camera, radar, lidar, ultrasonic or any other suitable sensing device.

The invention has been described herein as including directionality but not depth. However, the scope of the invention includes using depth and directionality working together and/or independently. For example, the presence of a school zone may not have directionality but it does have changing depth.

The word “intuitive” has been used above to describe features of the invention. It is to be understood that the word “intuitive” may refer to features having a behavior associated with a particular chosen sound.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a plurality of outside microphones mounted in association with an outer surface of the vehicle;
a plurality of loudspeakers disposed within a passenger compartment of the vehicle; and
a processing device configured to:
identify a sound of interest in outside microphone signals received from the outside microphones;
determine from the outside microphone signals a direction in which the sound of interest is approaching the vehicle; and
in response to the identification of the sound of interest, begin playing at least one of the outside microphone signals on the loudspeakers such that the sound of interest in the outside microphone signal and heard by a driver of the vehicle on the loudspeakers is perceived by the driver to be coming from the determined direction.

2. The motor vehicle of claim 1 wherein the processing device is configured to attenuate sounds other than the sound of interest in the outside microphone signal.

3. The motor vehicle of claim 1 further comprising an inside microphone disposed within a passenger compartment of the vehicle, the processing device including an active noise controller configured to use a signal from the inside microphone to attenuate:
sounds other than the sound of interest in the outside microphone signal; and/or
sounds originating in the vehicle.

4. The motor vehicle of claim 1 further comprising an audio system transmitting an audio signal to the loudspeakers, the processing device being configured to, in response to the identification of the sound of interest, attenuate the audio signal being played on the loudspeakers.

5. The motor vehicle of claim 1 wherein the outside microphones are mounted in positions substantially evenly spaced around a periphery of the vehicle.

6. The motor vehicle of claim 1 wherein the processing device is configured to identify the sound of interest in the microphone signals by detecting a frequency characteristic of the sound of interest in the microphone signals.

7. The motor vehicle of claim 1 wherein the sound of interest includes a noise caused by hard braking, a sound of a siren, or a sound of a crash.

8. A method of producing sounds in a motor vehicle, the method comprising:
mounting a plurality of outside microphones in association with an outer surface of the vehicle;
providing a plurality of loudspeakers within a passenger compartment of the vehicle;
identifying a sound of interest in outside microphone signals received from the outside microphones;
determining from the outside microphone signals a direction in which the sound of interest is approaching the vehicle; and
in response to the identifying of the sound of interest, commencing playing at least one of the outside microphone signals on the loudspeakers such that the sound of interest in the outside microphone signals and heard by a driver of the vehicle on the loudspeakers is perceived by the driver to be coming from the determined direction.

9. The method of claim 8 further comprising attenuating sounds other that the sound of interest in the outside microphone signal.

10. The method of claim 8 further comprising:
providing an inside microphone disposed within a passenger compartment of the vehicle; and
using a signal from the inside microphone to attenuate:
sounds other than the sound of interest in the outside microphone signal; and/or
sounds originating in the vehicle.

11. The method of claim 8 further comprising:
transmitting an audio signal from an audio system to the loudspeakers; and
in response to the identifying of the sound of interest, attenuating the audio signal being played on the loudspeakers.

12. The method of claim 8 wherein the outside microphones are mounted in positions substantially evenly spaced around a periphery of the vehicle.

13. The method of claim 8 wherein the sound of interest in the microphone signals is identified by detecting a frequency characteristic of the sound of interest in the microphone signals.

14. The method of claim 8 wherein the sound of interest includes a noise caused by hard braking, a sound of a siren, or a sound of a crash.

15. A motor vehicle, comprising:
a plurality of outside microphones mounted in association with an outer surface of the vehicle;
an inside microphone disposed within a passenger compartment of the vehicle;
a plurality of loudspeakers configured to emit sounds into a passenger compartment of the vehicle; and
a processing device configured to:
identify a sound of interest in outside microphone signals received from the outside microphones;
determine from the outside microphone signals a direction in which the sound of interest is approaching the vehicle; and
in response to the identification of the sound of interest, begin playing at least one of the outside microphone signals on the loudspeakers such that the sound of interest in the outside microphone signal and heard by a driver of the vehicle on the loudspeakers is perceived by the driver to be coming from the determined direction;
wherein the processing device includes an active noise controller configured to receive a signal from the inside microphone and to attenuate:
sounds other than the sound of interest in the outside microphone signal; and
sounds originating in the vehicle.

16. The motor vehicle of claim 15 wherein the processing device is configured to attenuate sounds other than the sound of interest in the outside microphone signal.

17. The motor vehicle of claim 15 further comprising an audio system transmitting an audio signal to the loudspeakers, the processing device being configured to, in response to the identification of the sound of interest, attenuate the audio signal being played on the loudspeakers.

18. The motor vehicle of claim 15 wherein the outside microphones are mounted in positions substantially evenly spaced around a periphery of the vehicle.

19. The motor vehicle of claim 15 wherein the processing device is configured to identify the sound of interest in the microphone signals by detecting a frequency characteristic of the sound of interest in the microphone signals.

20. The motor vehicle of claim 15 wherein the sound of interest includes a noise caused by hard braking, a sound of a siren, a sound of a vehicle horn, or a sound of a vehicular crash.
